(19) United States
(12) Patent Application Publication
(10) Pub. No.: US 2007/0220000 A1
(43) Pub. Date: Sep. 20, 2007

(54) Universal Cache

(76) Inventor: Aaron E. Walsh, Boston, MA (US)

Correspondence Address: Aaron Walsh, Suite 1406, 1 Nassau Street, Boston, MA, 02111, US

(21) Appl. No.: 11/695,383

(22) Filed: Apr. 2, 2007

Related U.S. Application Data
(63) Continuation of application No. 10/142,357, filed on May 9, 2002, now abandoned.
(60) Provisional application No. 60/289,752, filed on May 9, 2001.

(51) Int. Cl. G06F 17/30

(52) U.S. Cl. 707/8

(57) ABSTRACT

A method and apparatus for permitting a resource to be locally stored by any one of a plurality of programs (that use different first resource identifies) using a resource identifier mapping technique that makes the resource accessible to any local or remote program. To that end, a store request relating to the resource from one of the plurality of programs is received. The store request identifies the resource with a first resource identifier associated with the one of the plurality of programs. The first resource identifier is mapped to a global resource identifier having a standard format. The resource is then permitted to be stored based on the global resource identifier. In response to a retrieve request with a first resource identifier for the resource, the resource is retrievable via the global resource identifier. The retrieve request may be made by any one of the plurality or programs.

### PRIORITY

This patent application is a continuation of U.S. patent application Ser. No. 10/142,357, the disclosure of which is incorporated herein by reference. This U.S. patent application also claims priority from U.S. provisional patent application No. 60/289,752, naming Aaron Walsh as inventor, filed may 9, 2001, and entitled, “Universal Cache,” the disclosure of which is incorporated herein by reference.

### FIELD OF THE INVENTION

The invention relates generally to computer systems and, more particularly, the invention relates to caching downloaded documents for digital computer systems.

### BACKGROUND OF THE INVENTION

Over the past several years, advances have been made in caching systems for networked applications. Undesirably, however, this work has focused almost exclusively on cached content that resides (or operates) on a network server, or at the edge of the computer network (e.g., proxy servers for Web browsers).

Significantly, networked software applications typically maintain a private local cache that is not shared with other applications. This produces redundant storage and network transmission for each cached resource. For example, Web browser products such as Microsoft Corporation's “Internet Explorer” and Netscape Communications Corporation's “Navigator” each maintain their own local cache that is completely independent of one another. Because Internet Explorer and Navigator each maintains its own local cache, these applications needlessly duplicate network bandwidth consumption and local storage space for every cached resource they utilize. The same is true for any application that maintains its own private cache.

FIG. 1 schematically shows a prior art network arrangement in which applications each have their own local private cache as described above. Any software application that maintains its own local cache effectively consumes network and storage resources for its own purposes in this redundant manner. For example, a single cacheable resource is downloaded over the network at least once for each application that requests it, after which it may be stored in each application's own private local cache. Because any number of software applications installed on a given computing device may download and cache resources independent of one another, redundant network bandwidth and storage space is needlessly consumed.

More specifically, as illustrated by FIG. 1, a resource utilized by three different networked applications that each maintains a private cache on the same local system, for instance, ultimately requires three different network file transfers. These three different file transfers are required because each application fetches the resource itself. The resource also may be stored as a file in three different local caches (one for each application that caches it), needlessly consuming storage space. Thus, network communications and local storage are needlessly replicated for each application that requires the resource.

It currently is possible for some networked applications, such as some Web browsers, to access resources through a proxy cache. Known proxy caches retrieve and cache Web content on behalf of the Web browser in an effort to reduce overall bandwidth consumption and storage requirements. In cases where a proxy cache is shared by multiple Web browsers, the proxy cache reduces the overall amount of network bandwidth and local storage space that otherwise would be consumed, consequently speeding delivery of content to those applications that utilize the proxy cache.

Although using a proxy cache can reduce bandwidth consumption across a collection of Web browsers (e.g., browsers on a corporate or educational network), they do not address the local caching problem described above. Specifically, known proxy caches rarely, if ever, are installed on the end user's system. Instead, proxy caches typically are installed on a central networked computer that resides on a Local Area Network (LAN), Wide Area Network (WAN), or on the edge of a network connected to the larger Internet.

Proxy servers are designed to 1) fetch content on behalf of multiple clients residimg in a networked environment, and 2) to allow these clients to access the Internet through a shared connection. Consequently, proxy servers are not specifically designed for installation directly on the end user's system. As a result, proxy servers are not designed to reduce network and storage consumption from the perspective of the individual end user's computer system; they are typically accessed through a network connection for the purposes of providing caching services to a collection of networked of clients. Because known proxy caches are designed to run on a remote shared computer system or server, they generally are not appropriate for direct installation on the end user's system for the purposes of providing Universal Cache services to applications running on the local system.

### SUMMARY OF THE INVENTION

In accordance with one aspect of the invention, a method and apparatus for permitting a resource to be locally stored by any one of a plurality of programs (that use different first resource identifiers) map resource identifiers to a global resource identifier. To that end, a store request relating to the resource from one of the plurality of programs is received. The store request identifies the resource with a first resource identifier associated with the one of the plurality of programs. As noted above, the first resource identifier is mapped to a global resource identifier having a standard format. The resource is then permitted to be stored based on the global resource identifier. In response to a retrieve request with a first resource identifier for the resource, the resource is retrievable via the global resource identifier. The retrieve request may be made by any one of the plurality of programs.

In some embodiments, the method and apparatus further may receive a retrieve request to retrieve the resource. The retrieve request is received from a given program of the plurality of programs. The retrieve request also identifies the resource with a first resource identifier associated with the given program. The first resource identifier associated with the given program then is mapped to the global resource identifier. The resource is permitted to be retrieved based on the global resource identifier. The retrieved resource may be forwarded to the given program.

In illustrative embodiments, the resource is a World Wide Web page. Moreover, the store request may be intercepted within a computer system as it is forwarded to a local memory controller on the computer system. The resource also may include logic for determining if a global resource identifier is available for it to use. In addition, the resource may be stored in a manner that is retrievable by any of the plurality of programs.

In accordance with another aspect of the invention, a method and apparatus permit a resource to be retrieved from a local storage device by any one of a plurality of programs. The plurality of programs use different first resource identifiers to identify the resource. To that end, a retrieve request relating to the resource is received from a first of the plurality of programs. The retrieve request identifies the resource with a first resource identifier associated with the first of the plurality of programs. The first resource identifier then is mapped to a global resource identifier having a standard format. The resource then is permitted to be received based on the global resource identifier.

In some embodiments, the global resource identifier is remapped to the first resource identifier associated with the first of the plurality of programs. The resource then may be forwarded to the first of the plurality of programs. The resource is identified to the first of the plurality of programs by the first resource identifier associated with such program. Among other ways, the retrieve request may be received by intercepting it within a computer system as it is forwarded to a local memory controller on the computer system.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

The foregoing and advantages of the invention will be appreciated more fully from the following further description thereof with reference to the accompanying drawings wherein:

FIG. 1 schematically shows an exemplary prior art network arrangement in which applications each have independent local caches.

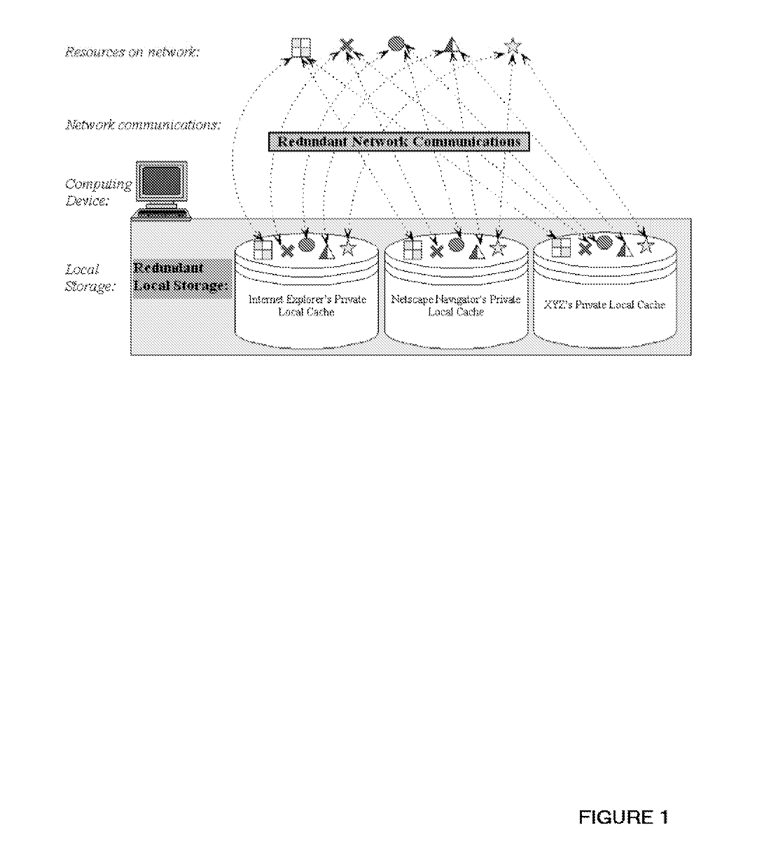

FIG. 2 schematically shows a local cache configured in accordance with illustrative embodiments of the invention.

FIG. 3 shows a process that a requesting application may use upon encountering a resource identifier in accordance with illustrative embodiments of the invention.

FIG. 4 shows resource processing directives that augment resource identifiers to enable programmable resources identifiers in accordance with illustrative embodiments of the invention.

### DESCRIPTION OF ILLUSTRATIVE EMBODIMENTS

In illustrative embodiments of the invention, World Wide Web browsers (hereinafter “browsers”) locally store downloaded World Wide Web pages (hereinafter “web pages”) and digital content resources within the web pages (web pages, digital content resources, and any other digital resource known in the art being referred to herein generally as “resources”) in a uniform manner. Accordingly, systems implementing this embodiment of the invention are capable of accessing resources downloaded by other vendors' browsers. This system is identified herein as “Universal Cache.”

It should be noted that the description is primarily made in terms of web pages and corresponding software, such as browsers. Those skilled in the art should understand, however, that discussion of web pages and browsers is exemplary and not intended to limit the scope of various embodiments of the invention.

In illustrative embodiments, Universal Cache resources (e.g., web pages and any digital resources within such web pages) may be accessed by any software application, regardless of whether that “requesting” application is local (either acting as the cache driver itself, or running on the same system as the cache system) or remote (connected by a network, similar to the way in which traditional Web proxy caches are used). When an application requests a Universal Cache resource that does not already reside in the cache, the application itself may fetch that resource and install it into its own private cache, or it may install the resource into a shared cache (acting as the cache). If installed into its own private cache, the Universal Cache system considers that browser's private cache to be an extension of the shared cache.

Alternatively, the application may defer this entire fetching and caching process to a caching application, such as a Universal Cache application (or proxy). Resources may be fetched from any device or service that offers them, including existing local or remote caches (such as private browser caches, traditional proxy caches,, etc. . . . ), network servers, peers of the client, databases, various network storage systems, and so forth. Only one network file transfer is required to fetch a resource in cases where the resource is not already local, and only one instance of that resource is required to exist in storage in cases where the resource is actually stored (persisted) directly by the system, or by some other mechanism (such as in a private browser cache).

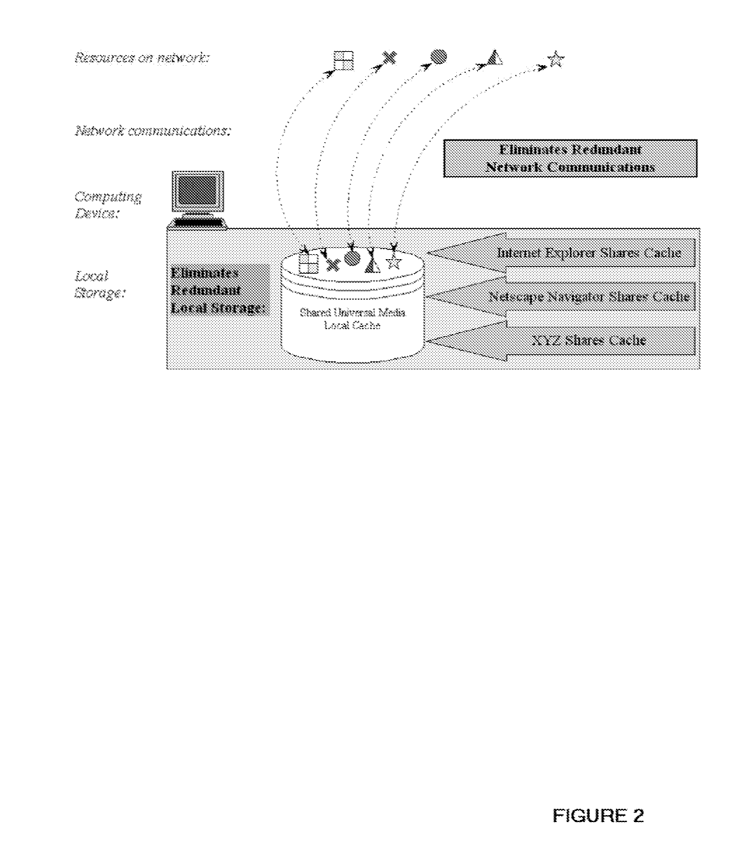

Cached items may be stored in a variety of forms, including computer files, database entries (such a Binary Large Objects, or BLOBs), storage networks, and other storage formats or mechanisms. Additionally, cached items may be stored using any combination of storage formats or mechanisms, and they do not require centralized management or location. A Universal Cache might simply coordinate or extend the functionality of various private local caches (by unifying various private caches that are created and maintained by Web browsers, for example, in an effort to eliminate redundant network transfers and storage requirements), or the system might provide an entirely separate caching solution independent of other caches. Once a resource is installed into the Universal Cache, or otherwise becomes known to the Universal Cache (such as when a Web browser places a resource into its own private cache), that resource is uniformly available to all local applications, effectively eliminating reduntant network transfers and subsequent storage requirements entirely (access to a resource may optionally be restricted by associating access policies with that resource). FIG. 2 graphically illustrates this inherent network transmission and storage savings when Universal Cache resources are accessed by different applications.

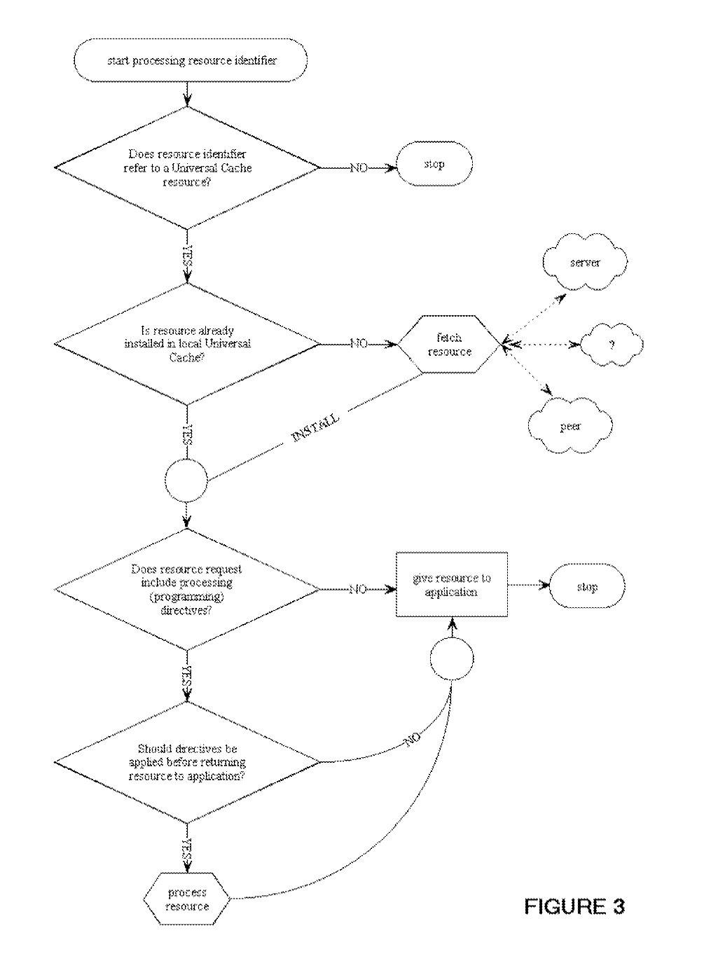

FIG. 3 shows an exemplary process that a requesting application or independent caching application might follow upon encountering a resource identifier known to the Universal Cache. The process begins at step 300, in which processing of a resource identifier begins. It then is determined at step 302 if the resource identifier refers to a Universal Cache resource. If the resource identifier does not refer to a Universal Cache resource, then the process ends. Conversely, if the resource identifier refers to a Universal Cache resource, then the process continues to step 304.

At step 304, it is determined if the resource already is installed in local Universal Cache. If not locally installed, then the process continues to step 306, in which the resource is fetched from any number of sources, such as a server or a peer computer. Alternatively, returning to step 304, if it is determined that the resource already is installed in the local Universal Cache, then the process continues to step 308. Specifically, at step 308, it is determined if the resource request includes processing (i.e., programming) directives. If not, then the resource is given to the application (step 310). If it does include processing directives, then the process continues to step 312 in which it is determined if the directives should be applied before returning the resource to the application. If not, then the process loops back to step 310, thus giving the resource to the application. Conversely, if the directives should be applied before returning the resource to the application, then the process continues to step 314, in which the resource is processed. The process then continues to step 310, in which the resource is given to the application.

Following is a summary of the various elements that make up an illustrative embodiment of the Universal Cache. Each element may be used by the process described above with regard to FIG. 3.

1) RESOURCES AND ASSOCIATED IDENTIFIERS

Every resource and category of resources in this system is associated with a globally unique identifier that may be optionally mapped with (i.e., associated with) other identifiers used to reference the resource (such as URLs).

Following is an example of a globally unique resource category identifier in the form of a Uniform Resource Name (URN):

urn:web3dmedia:nature:trees:oak

In this case, the identifier references a general category, or class, of resources because a unique resource is not specified. Thus, any number of specific resources may be available in this general category of named resources. Resource identifiers utilized by this embodiment permit unspecified file formats and content representations, as shown here, to enable applications to retrieve the format, rendition, or representation that is most appropriate for a given context, or which is generally preferred by the application. In such cases, the format or representation of the actual resource can be determined either by 1) the client application, 2) the server application responsible for delivering the requested resource to the client, or 3) through some form of negotiation between the client and server.

If, for example, a resource identifier is used in a context where a bitmap image is typically required, the client application can request that the resource be supplied in the image format it prefers. To do so, the application simply appends a corresponding file format extension to the more general resource identifier, or associates an appropriate processing directive with the resource identifier. The following identifier, for instance, specifies that the resource should be supplied to the application in the Portable Network Graphics (PTG) format:

urn:web3dmedia:nature:trees:oak.png

In this case the identifier is considered to be globally unique because it refers to a specific resource, whereas the previous identifier intentionally omits a file extension so that the application and/or server can select the resource in any format or content representation. If the application would instead prefer the server to determine the format of the returned object it could simply omit the file extension during the resolution request.

In cases where a resource identifier naming scheme or format is not directly supported by a given platform, operating system, storage device, or language, the system follows corresponding resource naming policies. Some versions of the MICROSOFT WINDOWS operating system, for example, do not allow colon characters “:” to appear in file names. Consequently, the previously cited resource and resource category identifiers are not legal Windows file names. Thus, Windows-compatible file names can be utilized for file storage purposes, while transparently allowing these resources to be retrieved from the cache based on their primary (or secondary) identifiers that might actually include colons. For example, when storing resources on Windows platforms the system might substitute the underscore character “_” for colons to enable file storage based on identifier names. For example, the file name urn_web3dmedia_nature_trees_oak.png might be used to store the resource that is globally identified by urn:web3dmedia:nature:trees:oak.png any time that resource is stored on a Windows system. Similarly, alternate character substitutions may be made on other platforms as required to facilitate storage based on identifier names.

Alternately, a completely different file name (such as a hash code, numeric value, database key, URL, etc.) may be used for the purposes of storage provided such resources may still be retrieved from the cache based on the identifier(s) associated with them. In this manner the Universal Cache supports resource identifier mapping schemes for a variety of platforms, operating systems, storage devices, and languages, specifically to overcome naming conflicts. Such mappings may be provided in any form or format required by the system, and may include meta data in addition to specific mappings. Following, for example, is pseudo-code for a simple data structure that maps the previously cited resource identifier to numerous other identifiers and names that might be associated with the same resource including URLs, file paths, hash codes and schemes, keys, keywords and descriptions, as also as a suite of character substitution mappings that are legal for this resource:

urn:web3dmedia:nature:trees:oak.png = {

“http://web3dmedia.com/nature/trees/oak.png”,
“http://www.mantiscorp.com/images/oak232.png”,
“http://www.livinglinks.com/photos?id=9e533,format=png”,
“C:\My Documents\graphics\artwork\photographs\oaktree.png”,
“urn_web3dmedia_nature_trees_oak.png”,
“543252345.png”,
“93265932935-353-353253-23532”,
“keywords = nature, tree, oak, png, web3dmedia”,
“description = Oak tree photograph in png format created by the

Web3D Media Group. Copyright 2002.”,

“hash algorithms = SHA1, GOST, HAVAL256, CRC32B, CRC32”,
“substitute ‘:’ with ‘_’ or ‘−’ or ‘ ’ or ‘+’”;

}

2) RESOURCE POLICIES AND PROCEDURES

Resource naming, resolution, and caching policies and procedures may be stored in a variety of formats (such as text, XML, HTML, binary, etc . . .) or in data storage systems, such as relational or object databases. By following these policies and procedures, all applications that participate in the Universal Cache do so in a uniform manner. Such policies and procedures may be applied on a resource-by-resource basis, on a category basis (i.e., for all resources in a given category), or on a namespace basis (i.e., for all resources in a given identifier namespace).

Naming refers to the act of associating a cacheable resource with a globally unique identifier, making that resource “known” to the system. Resource naming policies govern all aspects of resource naming and ensure that name collisions and conflicts are avoided across various platforms, operating systems, storage devices and languages.

Resolution refers to the act of retrieving, or fetching, a resource known to the Universal Cache based on its globally unique identifier or based on alternate identifiers (e.g., URLs) that are mapped to a unique identifier. Resource resolution polices define the rules and procedures that requesting applications and standalone caches follow during the resolution process. Assuming that a resource is already installed in the Universal Cache, or is available though an alternate local cache (such as a Web browser's private cache), the resolution process may take place locally and entirely within the control of the requesting applications or proxies (such as a standalone Universal Cache application).

If the resource is not available locally, then the resolution process may involve traditional proxy caches, networked servers and/or peers, depending on the resolution policy for that resource, thus enabling client-server and/or distributed peer-to-peer resource resolution. As discussed above, FIG. 3 illustrates a simple resolution process that a requesting application or caching application might follow upon encountering a resource known to the Universal Cache.

Caching refers to the act of storing resources in memory (RAM) or permanently on some form of fixed media, making them both persistent and in a well-known location. Caching reduces the time it takes to resolve resources when they are requested or otherwise needed. Resources known to the Universal Cache can reside locally (completely under the control of locally resident applications) or they may be distributed over the network so that the shared cache can be used by a collection of networked applications in much the same fashion as a traditional proxy cache. Caching policies govern all aspects of resource caching, such as how resources are stored locally or remotely, resource expiration, access logging, compression, cache maintenance such as deleting, pruning and optimization, security, encryption, authentication, license and/or payment requirements (i.e., pay-per-use, flat-fee, subscription rates), and so forth.

3) PROGRAMMABLE RESOURCE IDENTIFIERS

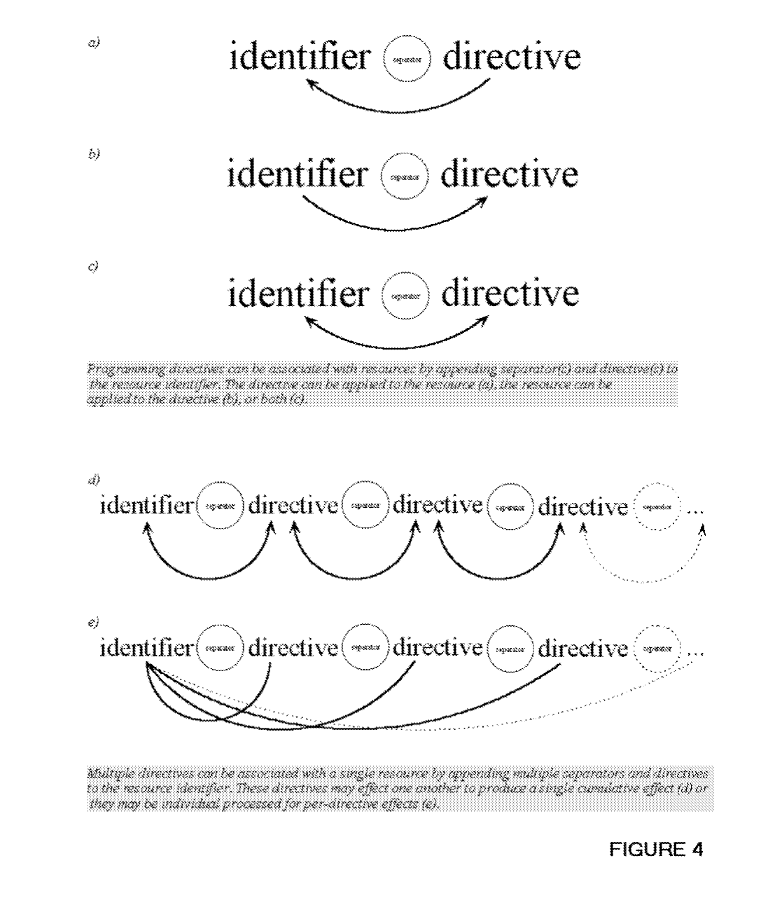

Resource processing directives augment resource identifiers to enable programmable resources identifiers (FIG. 4). Programmable resource identifiers may be supported on an application-specific basis, or on a global basis to which all applications must adhere (in which case the rules are defined in corresponding resource policies and procedures). These processing directives may also be stored outside of the identifier (in text files, XML files, databases, etc . . . ) in cases where embedding the directive into the identifier is not desired.

In the following embodiment, the period character (“.”) denotes dot notation message passing similar to that commonly found in Object Oriented Programming (OOP) languages such as Java. The following three conceptual examples show different ways in which this mechanism might be used to inform the system that the resource should be rotated forty-five degrees in the clockwise direction:

urn:web3dmedia:nature:trees:oak.rotate(45)

urn:web3dmedia:nature:trees:oak.(rotate=45)

urn:web3dmedia:nature:trees:oak.<rotate degrees=45>

In the following two embodiments, both parenthesis and brackets are used to separate the identifier from the operations associated with it, eliminating the need for the period separator used in the previous examples:

urn:web3dmedia:nature:trees:oak(rotate=45)

urn:web3dmedia:nature:trees:oak<rotate degrees=45>

In all of these examples, the application is free to request the resource in any format it desires because a specific file format is not included in the identifier. Alternately, the application can pass this responsibility on to the server if it does not desire a specific format. In such case, the server may deliver the resource in any format appropriate for the requesting application or through some form of negotiation with the requesting application.

Operations associated with resources may be performed by the cache system (or an application or service known to the cache system), the requesting application, or a combination of both. Continuing the previous examples, the requesting application can apply the specified rotation operation on the resource after it has received that resource from the cache (irrespective of where that resource comes from). Alternately, the cache can perform the rotation operation itself and deliver the rotated resource to the requesting application after the operation. In the case of complex operations, or in cases where multiple operations are specified, the cache (or associated applications or services) may perform some of the work, while other parts of it may be performed by the requesting application. Following are examples of how multiple operations may be specified for a single resource:

urn:web3dmedia:nature:trees:oak.rotate(45).invert( )

urn:web3dmedia:nature:trees:oak<rotate degrees=45><invert>

The types of operations that can be performed on resources are dependent on the resource's format or data type. In cases where an application receives a 2D image, for example, a simple bitmap rotation may be applied. In cases where the application receives a 3D object, however, a rotation transformation is more appropriate. Likewise, if the resource is ultimately an audio file the rotate operation must apply to sound data.

To this end, the following processing directive

urn:web3dmedia:nature:trees:oak.png

is functionally equivalent to requesting the resource using a processing directive that specifies an explicit Multipurpose Internet Mail Extension (MIME) format. Following are three different examples of how such an operation might be associated with a given resource by embedded programming directives into the resource identifier:

urn:web3dmedia:nature:trees:oak.setMimeType(“image/png”)

urn:web3dmedia:nature:trees:oak.(mime=“image/png”)

urn:web3dmedia:nature:trees:oak<format mime=“image/png”>

In cases where an application supports the Universal Cache system, requests that the application makes for resources may be made directly to a standalone Universal Cache program, which can process the request accordingly. Alternatively, the application itself may act in the capacity of a Universal Cache program. In cases where an application acts in the capacity of a Universal Cache program, it may provide naming, resolution, and/or caching services for any resources that it requires itself or on behalf of other programs.

In cases where an application does not explicitly support the Universal Cache system in any form or manner, some embodiments of the Universal Cache system may provide services to that application transparently and without requiring any updates or re-coding of that application. This may be accomplished by an embodiment of the Universal Cache system that inserts itself into the typical resource request/response process of a network-enabled application. Specifically, in some embodiments, the system intercepts resource requests made by the application, after which it can handle them accordingly. As long as the results of the request are returned to the application in the form, fashion, or format it expects under normal operations, the application should gain the services of Universal Cache transparently and without explicit knowledge of the system.

By way of example, conventional browsers do not support some embodiments of the Universal Cache system. However, this does not preclude the possibility of a standalone Universal Cache embodiment inserting itself into the normal URL resource request/response mechanism of a browser. When doing so, this embodiment transparently provides various Universal Cache services to that browser without that explicit involvement on the part of that browser. In such a situation, the Universal Cache system could simply test each URL used by the browser to determine if corresponding unique identifiers are known to the system. If a URL maps to an identifier used by the system, then that resource is considered to be “known” by the system. Consequently, the resource can be resolved by the system (and optionally cached, if necessary) and returned to the browser transparently and in the format it expects. In this way, the Universal Cache system can be used by applications both explicitly, as well as transparently and without their direct involvement.

In alternative embodiments, web pages can be configured to include additional coding that determines if the downloading machine includes the Universal Cache. If the requesting machine does not include the Universal Cache, then it merely permits normal web page downloading. Conversely, if it determines that the downloading machine includes the Universal Cache, then either 1) it can redirect the browser's request for the web page to the Universal Cache application, or 2) the additional coding in the page can interact with the Universal Cache, as needed, to dynamically generate the resource identifiers necessary for the browser to fetch resources from the local cache. The Universal Cache application then processes the page, or elements of the page, caching the downloaded data in the standardized format described herein, if necessary, and then returns the result to the browser. Because the Universal Cache application returns the downloaded data to the browser in a format that the browser normally uses to process downloaded web pages, the browser receives the benefits of the system transparently and without explicit knowledge of the additional interaction required to do so. Consequently, the Universal Cache application is configured with information relating to various different vendor web browsers and other applications that use digital resources known to the system.

Various embodiments of the invention may be implemented in any conventional computer programming language. For example, illustrative embodiments may be implemented in a procedural programming language (e.g., “C”) or an object oriented programming language (e.g., “C++”). Alternative embodiments of the invention may be implemented by discrete hardware elements, and/or as preprogrammed hardware elements (e.g., application specific integrated circuits and digital signal processors), or other related components.

Alternative embodiments of the invention may be implemented as a computer program product for use with a computer system. Such implementation may include a series of computer instructions fixed either on a tangible medium, such as a computer readable media (e.g., a diskette, CD-ROM, ROM, or fixed disk), or transmittable to a computer system via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions preferably embodies all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web).

Although various exemplary embodiments of the invention have been disclosed, it should be apparent to those skilled in the art that various changes and modifications can be made that will achieve some of the advantages of the invention without departing from the true scope of the invention. These and other obvious modifications are intended to be covered by the appended claims.

I claim:

1. A method of permitting a resource to be locally stored by any one of a plurality of programs, the plurality of programs using different first resource identifiers to identify the resource, the method comprising:
receiving a store request relating to the resource from one of the plurality of programs, the store request identifying the resource with a first resource identifier associated with the one of the plurality of programs;
mapping the first resource identifier to a global resource identifier having a standard format; and
permitting the resource to be stored based on the global resource identifier, the resource being retrievable, in response to a retrieve request with a first resource identifier for the resource, via the global resource identifier, the retrieve request being made by any one of the plurality of programs.

2. The method as defined by claim 1 wherein the resource is a World Wide Web page and any constituent resources that comprise the World Wide Web page.

3. The method as defined by claim 1 further comprising:
receiving a retrieve request to retrieve the resource, the retrieve request being received from a given program of the plurality of programs, the retrieve request also identifying the resource with a first resource identifier associated with the given program; and
mapping the first resource identifier associated with the given program to the global resource identifier; and
permitting the resource to be retrieved based on the global resource identifier.

4. The method as defined by claim 3 further comprising:
forwarding the retrieved resource to the given program.

5. The method as defined by claim 1 wherein the store request is intercepted within a computer system as it is forwarded to a local memory controller on the computer system.

6. The method as defined by claim 1 wherein the resource includes logic for determining if a global resource identifier is available for it to use.

7. The method as defined by claim 1 wherein the resource is stored in a manner that is retrievable by any of the plurality of programs.

8. A computer program product for use on a computer system for permitting a resource to be locally stored by any one of a plurality of programs, the plurality of programs using different first resource identifiers to identify the resource, the computer program product comprising a computer usable medium having computer readable program code thereon, the computer readable program code comprising:
program code for receiving a store request relating to the resource from one of the plurality of programs, the store request identifying the resource with a first resource identifier associated with the one of the plurality of programs;
program code for mapping the first resource identifier to a global resource identifier having a standard format; and
program code for permitting the resource to be stored based on the global resource identifier, the resource being retrievable, in response to a retrieve request with a first resource identifier for the resource, via the global resource identifier, the retrieve request being made by any one of the plurality of programs.

9. The computer program product as defined by claim 8 wherein the resource is a World Wide Web page and any constituent resources that comprise the World Wide Web page.

10. The computer program product as defined by claim 8 further comprising:
program code for receiving a retrieve request to retrieve the resource, the retrieve request being received from a given program of the plurality of programs, the retrieve request also identifying the resource with a first resource identifier associated with the given program; and
program code for mapping the first resource identifier associated with the given program to the global resource identifier; and
program code for permitting the resource to be retrieved based on the global resource identifier.

11. The computer program product as defined by claim 1 further comprising:
program code for forwarding the retrieved resource to the given program.

12. The computer program product as defined by claim 8 wherein the store request is intercepted within a computer system as it is forwarded to a local memory controller on the computer system.

13. The computer program product as defined by claim 8 wherein the resource includes program code for determining if a global resource identifier is available for it to use.

14. The computer program product as defined by claim 8 wherein the resource is stored in a manner that is retrievable by any of the plurality of programs.

15. A method of permitting a resource to be retrieved from a local storage device by any of a plurality of programs, the plurality of programs using different first resource identifiers to identify the resource, the method comprising:
receiving a retrieve request relating to the resource from a first of the plurality of programs, the retrieve request identifying the resource with a first resource identifier associated with the first of the plurality of programs;
mapping the first resource identifier to a global resource identifier having a standard format; and
permitting the resource to be retrieved based on the global resource identifier.

16. The method as defined by claim 15 further comprising:
remapping the global resource identifier to the first resource identifier associated with the first of the plurality of programs; and
forwarding the resource to the first of the plurality of programs, the resource being identified to the first of the plurality of programs by the first resource identifier.

17. The method as defined by claim 15 wherein the resource is a World Wide Web page and any constituent resources that comprise the World Wide Web page.

18. The method as defined by claim 15 wherein the retrieve request is intercepted within a computer system as it is forwarded to a local memory controller on the computer system.

19. A computer program product for use on a computer system for permitting a resource to be retrieved from a local storage device by any one of a plurality of programs, the plurality of programs using different first resource identifiers to identify the resource, the computer program product comprising a computer usable medium having computer readable program code thereon, the computer readable program code comprising:
program code for receiving a retrieve request relating to the resource from a first of the plurality of programs, the retrieve request identifying the resource with a first resource identifier associated with the first of the plurality of programs;
program code for mapping the first resource identifier to a global resource identifier having a standard format; and
program code for permitting the resource to be retrieved based on the global resource identifier.

20. The computer program product as defined by claim 19 further comprising:
program code for remapping the global resource identifier to the first resource identifier associated with the first of the plurality of programs; and
program code for forwarding the resource to the first of the plurality of programs, the resource being identified to the first of the plurality of programs by the first resource identifier.

21. The computer program product as defined by claim 19 wherein the resource is a World Wide Web page and any constituent resources that comprise the World Wide Web page.

22. The computer program product as defined by claim 19 further comprising program code for intercepting the retrieve request within a computer system as the retrieve request is forwarded to a local memory controller on the computer system.
